(19) United States
(12) Patent Application Publication
(10) Pub. No.: US 2024/0419629 A1
(43) Pub. Date: Dec. 19, 2024

(54) UNIFIED STORAGE SYSTEM AND UPGRADE METHOD THEREFOR

(71) Applicant: Hitachi, Ltd., Tokyo (JP)

(72) Inventors: Takayuki FUKATANI, Tokyo (JP); Norio SHIMOZONO, Tokyo (JP); Mitsuo HAYASAKA, Tokyo (JP); Yuto KAMO, Tokyo (JP)

(73) Assignee: Hitachi, Ltd., Tokyo (JP)

(21) Appl. No.: 18/443,860

(22) Filed: Feb. 16, 2024

(30) Foreign Application Priority Data
Jun. 15, 2023 (JP) 2023-098682

(51) Int. Cl. G06F 16/11; G06F 16/182

(52) U.S. Cl. CPC G06F 16/119; G06F 16/183

(57) ABSTRACT

A unified storage system is capable of reducing hardware costs by effectively utilizing a previously used storage controller when upgrading a storage controller in a unified storage and an upgrade method for the unified storage system is possible. The unified storage system A includes: a storage node having a controller; and a storage device configured to store data. In the unified storage system, the unified storage system supports block access and file access, the unified storage system includes a file system, which is configured to process file access from a client and perform block access to the controller, the controller processes block access from the client and block access from the file system to access the storage device which stores the data, and the unified storage system is capable of adding a network-connected information apparatus and is capable of migrating the file system to the information apparatus.

### BACKGROUND

The present invention relates to a unified storage system and an upgrade method for the unified storage system.

A unified storage which provides both block access and file access via a network in a single storage chassis has recently been in demand due to demands for lower hardware costs and lower power consumption.

According to U.S. Pat. No. 9,430,480, it discloses a technology of realizing a unified storage which performs block protocol processing and file protocol processing in a single storage chassis.

### SUMMARY

In a unified storage, for example, file protocol control and block protocol control are run by the same storage controller to configure an HA (High availability) cluster. By causing two or more storage controllers to share a storage device unit which is a data storage area, the service can be taken over by another storage controller in the event of failure or maintenance work on one storage controller. Further, the performance can be upgraded without migration of data (Data-in-place) by replacing the storage controller with a high-performance storage controller.

At this time, it is desirable to effectively utilize an apparatus which was used before the upgrade to reduce hardware costs. In the conventional method, the storage controller which was used before the upgrade becomes unused, thus resulting in an increase in hardware costs correspondingly.

An object of the present invention is to provide a unified storage system capable of reducing hardware costs by effectively utilizing a previously used storage controller when upgrading a storage controller in a unified storage, and an upgrade method for the unified storage system.

In order to solve the above problem, the present invention provides the unified storage system including: a storage node having a controller; and a storage device configured to store data, and supporting block access and file access. The unified storage system includes a file system, which is configured to process file access from a client and perform block access to the controller. In the unified storage system, the controller processes block access from the client and block access from the file system to access the storage device which stores the data, and the unified storage system is capable of adding a network-connected information apparatus and is capable of migrating the file system to the information apparatus. In this case, when upgrading the storage controller (network interface) in the unified storage, a managing device can be provided which is capable of reducing hardware costs by effectively utilizing a previously used network interface.

Here, after a file system is migrated, a file system of an information apparatus can perform block access to a controller of a storage node. In this case, the originally used network interface can be effectively utilized.

The storage node also has a network interface having a processor, and the file system can be made to run on the network interface before its migration. In this case, it becomes easy to construct a unified storage system.

Further, when upgrading the configuration of any of the storage nodes, the file system can be migrated to the information apparatus. In this case, when any of the components of the storage nodes runs out of resources, the component with insufficient resources can be upgraded.

Furthermore, when migrating the file system, the configuration information of the file service can be migrated from the storage node to the information apparatus. In this case, the same file system as the network interface used before the upgrade is used in the information apparatus used after the upgrade, so that there is no need to migrate file data at the time of the performance upgrade.

In addition, the storage node has a plurality of network interfaces each having a processor. Before migrating of the file system, a plurality of file systems running on the multiple network interfaces cooperate with each other to configure a distributed file system. After the file system is migrated, a plurality of file systems running on a plurality of information apparatuses can cooperate with each other to configure a distributed file system. In this case, the performance can be scaled out by increasing the number of network interfaces used before the upgrade or the number of apparatuses used after the upgrade.

Moreover, when migrating the file system, data referenced by the file system is migrated to the storage device of the information apparatus. After the migration, the file system can access the storage device of the information apparatus. In this case, even when different file systems are used between the network interface used before the upgrade and the information apparatus used after the upgrade, the upgrade is possible.

Furthermore, the storage node has a network interface, and before migrating the file system, a block access path and a file access path from a client are set up on the network interface of the storage node. After migrating the file system, the file access path from the client can be set up on the information apparatus in a state in which the block access path from the client is set up on the network interface of the storage node. In this case, it is possible to bring about a situation in which block access and file access can be made from outside.

Then, after the file system is migrated, the storage node and the information apparatus share a secret key, and it is possible for them to perform communication including block access between the storage node and the information apparatus, by using the secret key. In this case, it is possible to maintain security in the event of an upgrade.

In addition, the storage node has a network interface, and the network interface has a memory in which file-accessed data is temporarily stored. When the file system is migrated, dirty data in the memory of the network interface can be stored in the storage device. In this case, it is possible to prevent data inconsistency before and after the migration.

Furthermore, the information apparatus can be an external server or a NAS gateway server. In this case, it is possible to eliminate the performance bottleneck of the network interface.

Further, this invention provides the upgrade method for the unified storage system including: a storage node having a controller; and a storage device configured to store data, to support block access and file access, and the upgrade method includes: providing a file system, which is configured to process file access from a client and perform block access to the controller; causing the controller to process block access from the client and block access from the file system to access the storage device that stores the data; and causing the unified storage system to add a network-connected information apparatus and to migrate the file system to the information apparatus. In this case, when upgrading the storage controller (network interface) in the unified storage, an upgrade control system can be provided which is capable of reducing hardware costs by effectively utilizing a previously used storage controller.

According to the present invention, it is possible to provide a unified storage system capable of reducing hardware costs by effectively utilizing a previously used storage controller when upgrading a storage controller in a unified storage, and an upgrade method for the unified storage system. In addition, the present invention allows a storage controller to be reused, thereby making it possible to reduce an environmental burden.

### BRIEF DESCRIPTION OF THE DRAWINGS

FIG. 1 is an overall configuration diagram of a unified storage system according to a first embodiment, and is a schematic diagram of a performance upgrade system of a unified storage in the first embodiment;

FIG. 2 is an overall configuration diagram of the unified storage in the first embodiment;

FIG. 3 is a configuration diagram of a controller of the unified storage in the first embodiment;

FIG. 4 is a configuration diagram of an FE I/F of the unified storage in the first embodiment;

FIG. 5 is an example of a configuration diagram of an external server in the first embodiment;

FIG. 6 is an example of a configuration diagram of a management server in the first embodiment;

FIG. 7 is an example of a configuration diagram of a client in the first embodiment;

FIG. 8 is a diagram illustrating an example of a port management table;

FIG. 9 is a diagram illustrating an example of an LDEV management table;

FIG. 10 is a diagram illustrating an example of an LU management table;

FIG. 11 is a diagram illustrating an example of an FS management table;

FIG. 12 is a diagram illustrating an example of a file share management table;

FIG. 13 is a diagram illustrating an example of an FE I/F management table;

FIG. 14 is a diagram illustrating an example of a block device management table;

FIG. 15 is a diagram illustrating an example of an HA management table;

FIG. 16 is a flowchart illustrating an example of performance upgrade processing S1 of the unified storage in the first embodiment;

FIG. 17 is a flowchart illustrating an example of file service setting processing S130 of the external server of the unified storage in the first embodiment;

FIG. 18 is an example of file service migration processing S150 of the unified storage in the first embodiment;

FIG. 19 is an example of a performance upgrade interface of the unified storage in the first embodiment;

FIG. 20 is an overall configuration diagram of a unified storage system according to a second embodiment, and is a schematic diagram of a performance upgrade system of a unified storage in the second embodiment;

FIG. 21 is an example of a configuration diagram of a NAS gateway server in the second embodiment;

FIG. 22 is a flowchart illustrating an example of performance upgrade processing S2 of the unified storage in the second embodiment;

FIG. 23 is a flowchart illustrating an example of file setting/data migration processing S220 of the NAS gateway server in the second embodiment; and

FIG. 24 is an overall configuration diagram of a unified storage system according to a third embodiment, and is a schematic diagram of a performance upgrade system of a unified storage in the third embodiment.

### DETAILED DESCRIPTION

Embodiments of the present invention will hereinafter be described in detail with reference to the accompanying drawings.

Note that in the following description, block access is a data access method in which data is read and written in units of fixed-length blocks. A storage which provides the block access divides a physical storage area into LUs (Logical Units) and allows a client to access data in block units. A block protocol is a communication protocol which realizes the block access via a network.

Further, file access is a data access method of reading and writing data in variable-length management units called files. A storage which provides the file access uses a file system function of storing file data in LUs to allow a client to access data in file units. A file protocol is a communication protocol which realizes the file access via a network. In addition, a shared area of a file system which is open to the client is called a file share.

Moreover, in the above example, the problem of the invention was to reduce hardware costs by effectively utilizing the originally-used apparatus, but the point to prevent performance/reliability degradation during an upgrade is also given as a second problem. In the conventional method, when replacing a storage controller, it is necessary to fail over file protocol control and block protocol control which have been running on the storage controller being replaced to another storage controller. As a result, the load is concentrated on the storage controller as the failover destination, a single point of failure occurs, and both performance and reliability degrade. Therefore, a challenge is to reduce the performance and reliability during the replacement of the storage controller and realize stable service provision.

### First Embodiment

In the first embodiment, a unified storage (SmartNIC unified) is assumed in which a SmartNIC (Smart Network Interface Card) is installed in a block storage, and file protocol processing is performed by the SmartNIC. The SmartNIC is a network interface device equipped with a CPU (Central Processing Unit) and a memory, and can run a general-purpose operating system (OS) and an OSS (Open Source Software) protocol server as is. The SmartNIC unified provides both block protocol processing and file protocol processing to a client by allowing the SmartNIC to perform the file protocol processing.

Although the SmartNIC unified is easy to construct, the CPU built into the SmartNIC with low processing power and is likely to become a CPU bottleneck due to file processing high in load. Therefore, there is needed a way to upgrade the performance by starting with the SmartNIC unified and then replacing the SmartNIC for users who need even more performance. However, when replacing the SmartNIC in the SmartNIC unified, there is mentioned a problem of as in the prior art, making effective use of a replacement device and suppressing degradation in performance and reliability during an upgrade.

Therefore, in the first embodiment, when the SmartNIC becomes a performance bottleneck in the SmartNIC unified, a way to upgrade the performance is provided to an external general-purpose server (hereinafter referred to as an external server) equipped with a high-performance CPU. In the present embodiment, even after the performance of the SmartNIC is upgraded to the external server, the apparatus before replacement is effectively utilized by continuously using the existing SmartNIC as a block access I/F for block access. Further, an HA cluster is configured between the external servers in advance, thereby enabling file protocol control to be migrated from the SmartNIC to the external server while maintaining an active-active configuration. This suppresses degradation in performance and reliability during an upgrade.

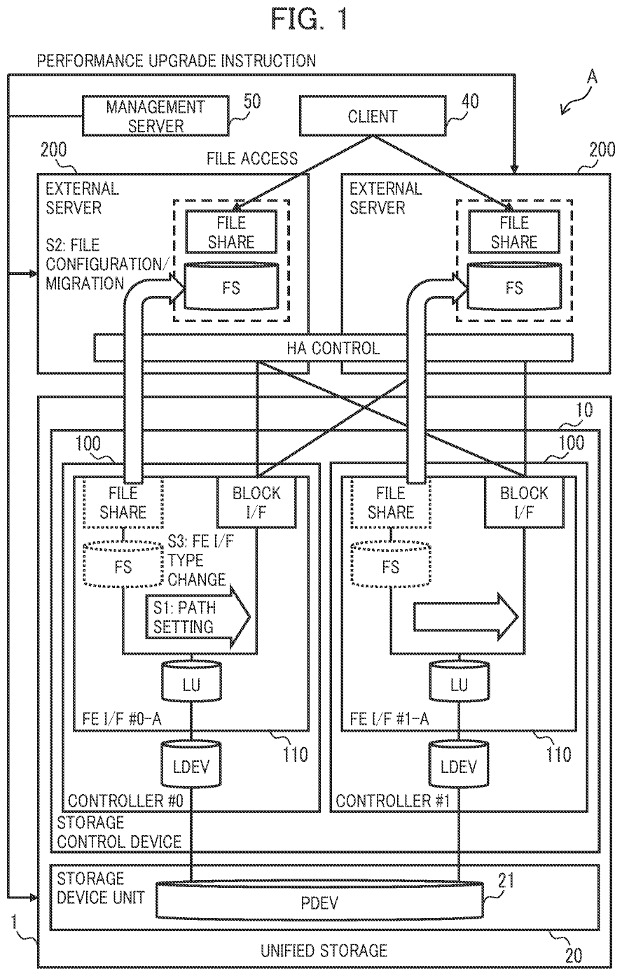

A first embodiment will hereinafter be described using FIGS. 1 to 19.

### Summary of First Embodiment

FIG. 1 is an overall configuration diagram of a unified storage system A according to the first embodiment, and is a schematic diagram of a performance upgrade system of a unified storage 1 in the first embodiment.

In the unified storage 1, each FE I/F (Front End Interface) 110 is connected to a controller #0 100 and a controller #1 100. The controller #0 100 and the controller #1 100 constitute an HA cluster. FE I/Fs 110 which run on each controller 100 also span the controllers and configure an HA cluster therebetween. In the present embodiment, the FE I/F 110 is an example of an FE I/F device.

The SmartNIC is used in the FE I/F 110 to configure a file share with a file system (FS) on a CPU. The FE I/F 110 stores data of the file system in an LU provided by the controller 100. The FE I/F 110 provides file access to a client by exposing the file system via the file share using a file protocol. Further, the FE I/F 110 provides block access to a client by exposing the LU using a block protocol.

When the CPU of the FE I/F 110 becomes a performance bottleneck, a management server 50 performs a performance upgrade to an external server 200 by performing processing of S1 to S3 shown below.
(S1) The management server 50 instructs the unified storage 1 to set up an additional external path for the LU used in the file system so that it can be externally connected thereto. This allows the LU to be accessed via block protocol from the file system in the FE I/F 110 from the outside.
(S2) The management server 50 uses file system and file share configuration information (network configuration, share configuration, authentication server) acquired from the unified storage 1 to configure, in an external server 200, a file system and a file share equivalent to the FE I/F 110. The management server 50 configures an HA cluster between the external servers 200. Thereafter, the management server 50 switches an access destination from a host to the external server 200. Specifically, GARP (Gratuitous Address Resolution Protocol) is used to switch an access destination of an IP address from the host. GARP referred to here is a protocol used to upgrade address information caches with respect to the apparatus within the same network. GARP allows switching an access destination of an IP address of a client or network switch. In this case, the file system and the file share can be migrated to the external server while maintaining the active-active configuration. This suppresses degradation in performance and reliability during an upgrade, which was a problem in the conventional method.
(S3) The management server 50 switches the type of the FE I/F 110 from file/block protocol sharing to block protocol only. Further, the processing performance of the block protocol is improved by allowing block protocol control to occupy a CPU and a memory resource allocated to the file protocol control. This realizes effective utilization of the apparatus that was in use prior to being replaced, which was a problem in the conventional method.

With the method described above, it is possible to increase performance by upgrading to a configuration in which the unified storage 1 using the SmartNIC is connected to the external server 200. Using this method enables the problem of upgrading the performance of the conventional unified storage to be solved.

Note that although the first embodiment assumes the unified storage 1 using the SmartNIC, this is merely an example. The present embodiment is also applicable to a unified storage in which file protocol control and block protocol control coexist within a conventional storage controller.

Also, in the first embodiment, it is assumed that the HA cluster is configured between the two FE I/Fs 110, but this is merely an example. The present embodiment can also be applied to an N-node cluster type unified storage which assembles an HA configuration with a plurality of nodes.

Further, although the first embodiment illustrates the configuration using the block storage, this is merely an example. The present embodiment can also be applied to a storage controller using a general-purpose server.

In addition, in the first embodiment, it is assumed that the SmartNIC is used as the FE I/F 110, but this is merely an example. The present invention can also be applied to an FE I/F equipped with an FPGA (Field Programmable Gate Array) or an independently-developed SoC (System on a chip) type FE I/F.

### System Configuration of First Embodiment

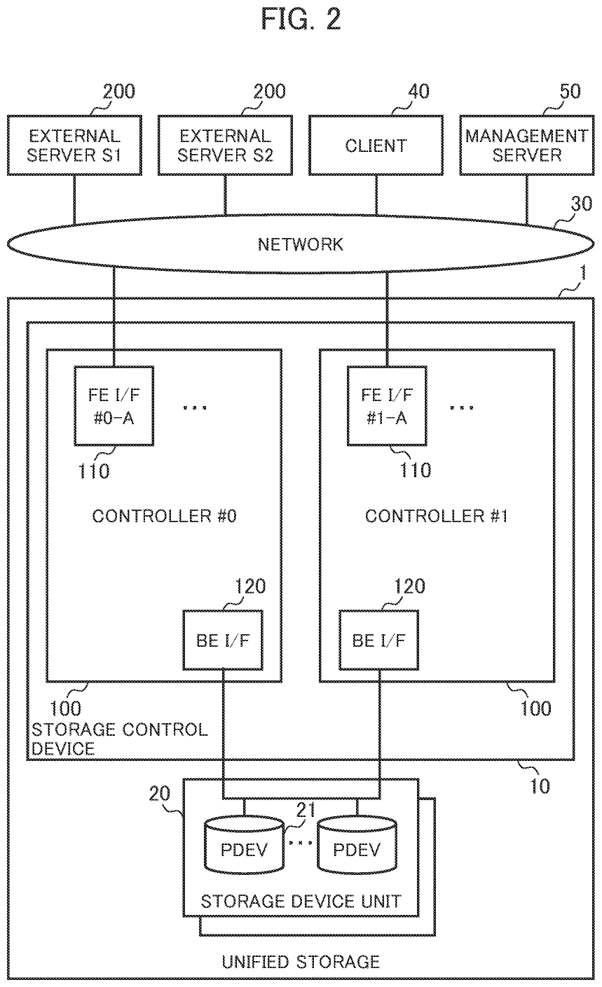

FIG. 2 is an overall configuration diagram of the unified storage 1 in the first embodiment.

The unified storage 1 is connected to a client 40, a management server 50, and an external server 200 via a network 30.

The unified storage 1 has a storage control device 10 and a storage device unit 20. The storage control device 10 is an example of a storage node and has a plurality of controllers 100. In order to improve the availability of the unified storage 1, a dedicated power supply may be prepared for each controller 100, and power may be supplied to each controller 100 using the dedicated power supply. Further, there may be a plurality of storage control devices 10, and the controllers 100 may be interconnected via an HCA (Host Channel Adaptor) network.

The controller 100 has an FE I/F 110 and a BE I/F (Back End Interface) 120.

The storage device unit 20 is an example of a storage device which stores data therein, and has a plurality of PDEVs (Physical Devices) 21. The PDEV 21 may be an HDD (Hard Disk Drive), but may be another type of storage device (non-volatile storage device), for example, an FM (Flash Memory) device such as an SSD (solid State Drive). The storage device unit 20 may have different types of PDEVs 21. Further, a RAID (Redundant Array of Inexpensive Disks) group may be configured with a plurality of PDEVs 21 of the same type. Data is stored in the RAID group according to a predetermined RAID level.

The network 30 is, for example, a LAN (Local Area Network), a WAN (Wide Area Network), or a SAN (Storage Area Network).

The client 40 is a device which accesses the unified storage 1 and transmits data input/output requests (data write request and data read request) to the unified storage 1. The client 40 transmits data input/output requests in block units or file units to the unified storage 1.

The management server 50 is equipped with a user interface such as a GUI (Graphical User Interface) or a CLI (Command Line Interface), and provides functions for a user or an operator to control and monitor the unified storage 1.

The external server 200 is a general-purpose server for general-purpose use. The external server 200 has a high-performance CPU, a large capacity memory, and a wideband network I/F.

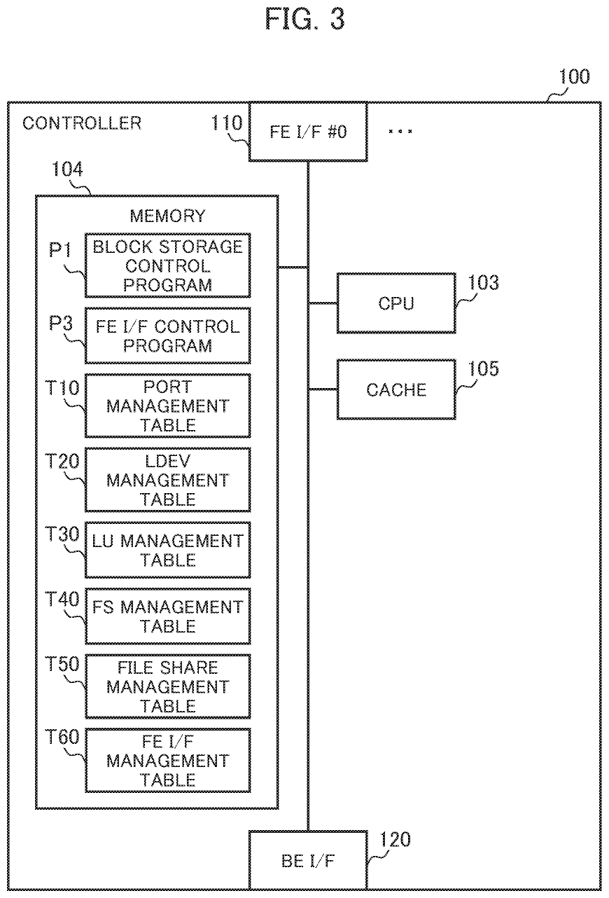

FIG. 3 is a configuration diagram of the controller 100 of the unified storage 1 in the first embodiment.

The controller 100 includes an FE I/F 110, a BE I/F 120, a CPU 103, a memory 104, and a cache 105. These are interconnected by, for example, a communication path such as a bus.

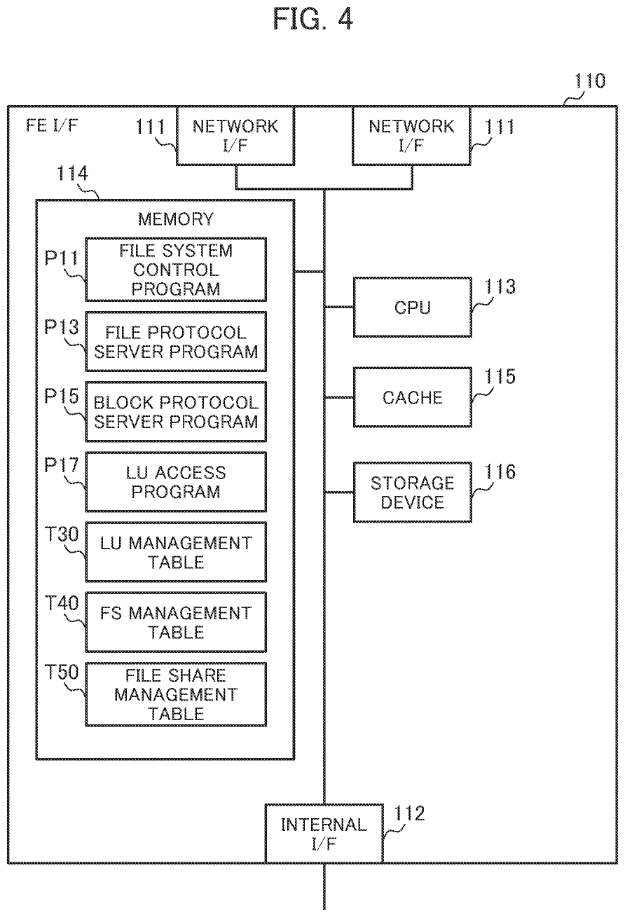

The FE I/F 110 is a programmable network interface using the SmartNIC or the like. In the first embodiment, a file system runs on the FE I/F 110. Details of the FE I/F 110 will be described later using FIG. 4.

The BE I/F 120 is an interface device for the controller 100 to communicate with the storage device unit 20. The FE I/F 110 stores data of the file system in the storage device unit 20.

The CPU 103 controls the operation of block storage.

The memory 104 is, for example, a RAM (Random Access Memory), and temporarily stores programs and data for controlling the operation of the CPU 103. There are stored in the memory 104, a block storage control program P1, an FE I/F control program P3, a port management table T10, an LDEV (Logical Device) management table T20, an LU management table T30, an FS management table T40, a file share management table T50, and an FE I/F management table T60. Note that the block storage control program P1, the FE I/F control program P3, and tables stored in the memory 104 may be stored in the storage device unit 20. The block storage control program P1 provides the FE I/F 110 with a logical device (LDEV) which is a logical storage area based on the storage device unit 20. The FE I/F 110 can access any LDEV by specifying an LDEV identifier. Thus, the FE I/F 110 can use the LDEV as a storage destination for an LU provided to a client or use the LDEV as a storage destination for file system data. The FE I/F control program P3 controls the FE I/F 110 stored on the memory. The FE I/F control program P3 initializes the FE I/F 110 and synchronizes the LU management table T30, the FS management table T40, and the file share management table T50 with the FE I/F 110.

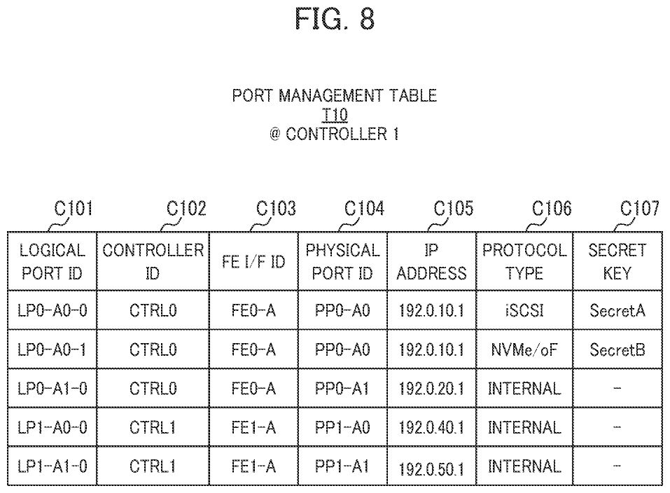

Details of the various tables will be described later using FIGS. 8 to 13.

The cache 105 temporarily stores write data from the client 40 and the FE I/F 110 and data read from the storage device unit 20.

FIG. 4 is a configuration diagram of the FE I/F 110 of the unified storage 1 in the first embodiment.

The FE I/F 110 has a network I/F 111, an internal I/F 112, a CPU 113, a memory 114, a cache 115, and a storage device 116. These are interconnected by, for example, a communication path such as a bus.

The network I/F 111 is an interface device for communicating with the external server 200, the client 40, and the management server 50. A logical port having an IP address is set up in the network I/F 111. The IP address is an identifier on the network, and the client 40 and the external server 200 communicate with the FE I/F 110 by the IP address set up in the logical port.

The internal I/F 112 is an interface device which communicates with the controller 100. The internal I/F 112 is connected to the CPU of the controller 100 and the like by PCIe (Peripheral Component Interconnect-Express), for example.

The CPU 113 is an example of a processor and controls the operation of the FE I/F 110.

The memory 114 temporarily stores programs and data used to control the operation of the CPU 113. A file system control program P11, a file protocol server program P13, a block protocol server program P15, an LU access program P17, an LU management table T30, an FS management table T40, and a file share management table T50 are stored in the memory 114. Further, each program and information stored in the memory 114 may be stored in the storage device 116.

The file system control program P11 is executed by the CPU 113 to control the file system and provide it to the file protocol server program P13. The file system control program P11 stores data in the LDEV allocated by the controller 100.

The file protocol server program P13 receives various requests such as Read/Write from the client 40, etc., and processes file protocols included in the requests. The file protocol server program P13 processes protocols such as an NFS (Network File System), an SMB (Server Message Block), a file system unique protocol, and an HTTP (Hypertext Transfer Protocol), for example.

The block protocol server program P15 receives various requests such as Read/Write from the client 40, etc., and processes block protocols included in the requests. The block protocol server program P15 processes protocols such ss an iSCSI, an NVMe/TCP (Non-Volatile Memory Express over TCP), and an FC (Fibre Channel), for example.

The LU access program P17 communicates with the controller 100 and processes data writing and reading to and from the LDEV. The file system control program P11 and the block protocol server program P15 use the LU access program P17 to read and write data stored in the LDEV. The tables are synchronized with the tables on the controller by the FE I/F control program P3.

The cache 115 temporarily stores data written from the client 40 and data read from the controller 100. The storage device 116 stores the operating system, management information, etc. of the FE I/F 110.

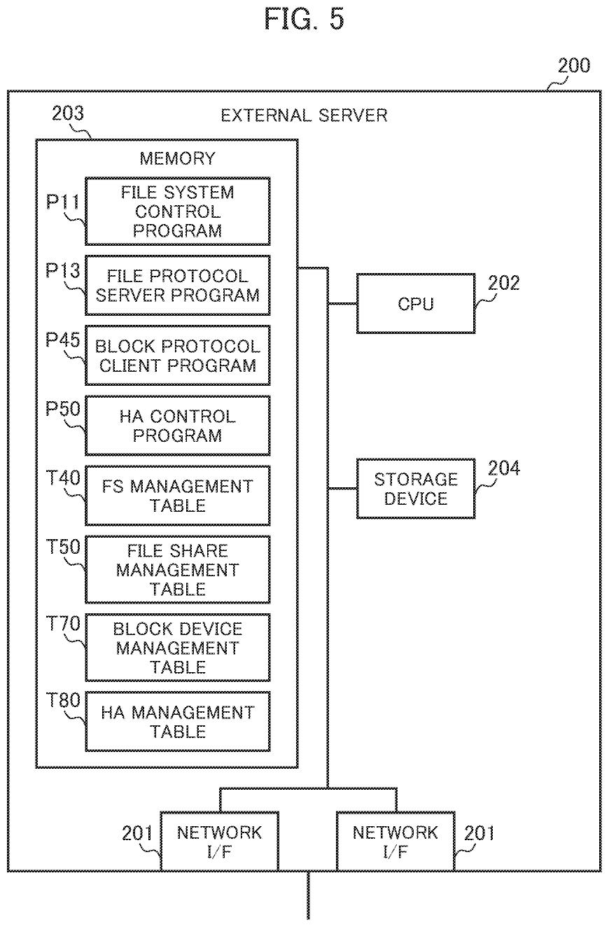

FIG. 5 is an example of a configuration diagram of the external server 200 in the first embodiment.

The external server 200 has a network I/F 201, a CPU 202, a memory 203, and a storage device 204. These are interconnected by, for example, a communication path such as a bus.

The network I/F 201 is an interface device for communicating with the unified storage 1, the management server 50, and the client 40.

The CPU 202 controls the operation of the external server 200.

The memory 203 temporarily stores programs and data used to control the operation of the CPU 202. A file system control program P11, a file protocol server program P13, a block protocol client program P45, an HA control program P50, an FS management table T40, a file share management table T50, a block device management table T70, and an HA management table T80 are stored in the memory 203. Each program and information stored in the memory 203 may be stored in the storage device 204.

The storage device 204 stores the operating system, management information, etc. of the external server 200.

The file system control program P11 controls the file system and provides it to the file protocol server program P13. The file system control program P11 stores data in the LU provided by the unified storage 1. The block protocol client program P45 communicates with the unified storage 1 using the block protocol and stores data in the LU.

The file protocol server program P13 receives various requests such as Read/Write from the client 40 and the like, and processes file protocols included in the requests.

The file system control program P11 and the file protocol server program P13 become equivalent to programs stored in the memory of the FE I/F 110.

The block protocol client program P45 receives various requests such as Read/Write from the client 40, etc., and processes block protocols included in the requests. The block protocol client program P45 processes protocols such as an iSCSI, an NVMe/TCP, and an FC, for example.

The HA control program P50 monitors each other's services between the external servers and migrates the file system and file share of the failed server to another sever when a failure occurs.

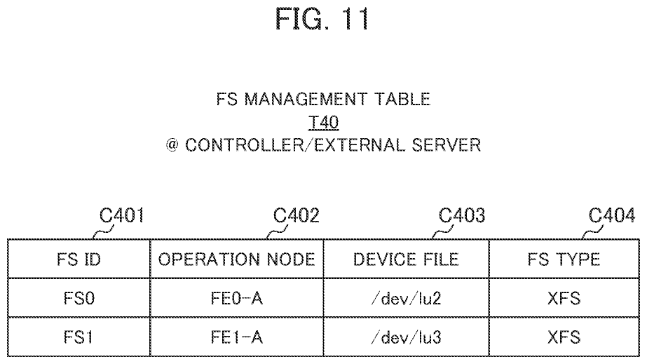

Details of the various tables will be described later using FIGS. 11, 12, 14, and 15.

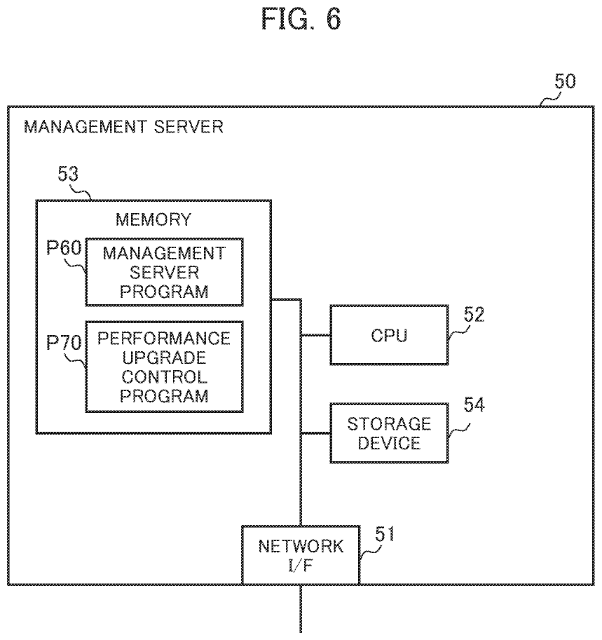

FIG. 6 is an example of a configuration diagram of the management server 50 in the first embodiment.

The management server 50 has a network I/F 51, a CPU 52, a memory 53, and a storage device 54. These are interconnected by, for example, a communication path such as a bus.

The network I/F 51 is an interface device for communicating with the unified storage 1 and the external server 200.

The CPU 52 controls the operation of the management server 50.

The memory 53 temporarily stores programs and data used to control the operation of the CPU 52. A management server program P60 and a performance upgrade control program P70 are stored in the memory 53. Each program and information stored in the memory 53 may be stored in the storage device 54.

The storage device 54 is an example of a memory and stores the operating system, management information, etc. of the management server 50.

The management server program P60 includes a user interface such as a GUI, a CLI or the like and provides functions for a user or operator to control and monitor the unified storage 1. When the management server program P60 receives a control instruction or a monitoring instruction for the unified storage 1 or the external server 200 from the user, the management server program P60 communicates with the unified storage 1 or the external server 200 and performs control or monitoring.

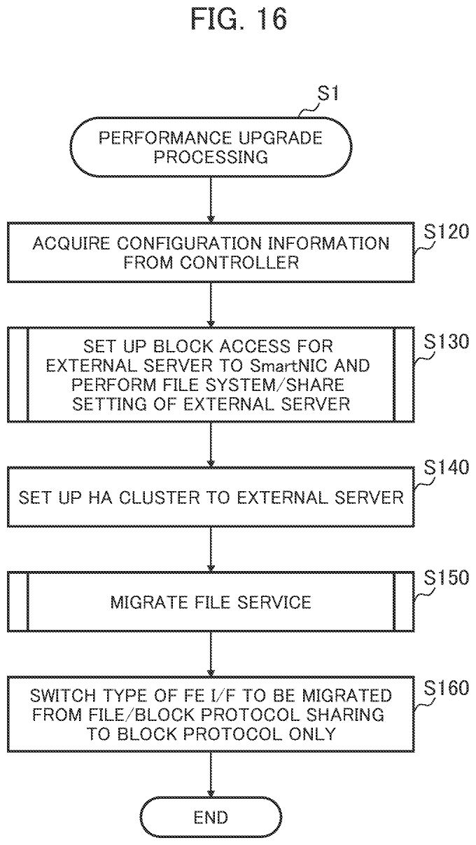

The performance upgrade control program P70 controls performance upgrade processing of the FE I/F 110. Details of the performance upgrade processing by the performance upgrade control program P70 will be described later using FIG. 16.

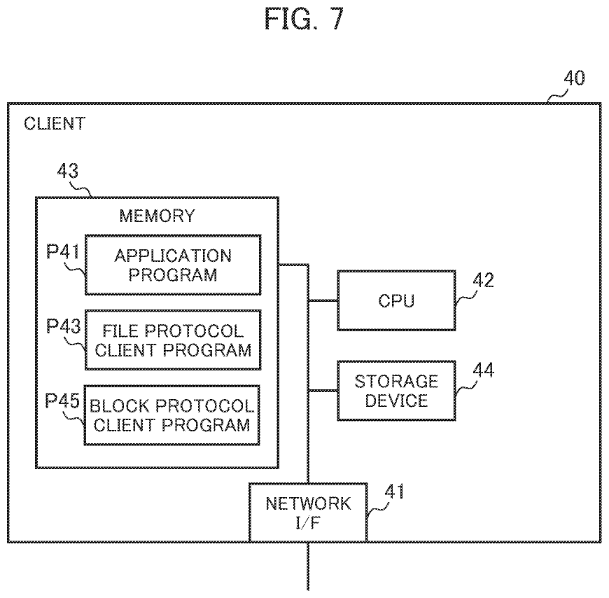

FIG. 7 is an example of a configuration diagram of the client 40 in the first embodiment.

The client 40 has a network I/F 41, a CPU 42, a memory 43, and a storage device 44. These are interconnected by, for example, a communication path such as a bus.

The network I/F 41 is an interface device for communicating with the unified storage 1 and the external server 200.

The CPU 42 controls the operation of the client 40.

The memory 43 temporarily stores programs and data used to control the operation of the CPU 42. An application program P41, a file protocol client program P43, and a block protocol client program P45 are stored in the memory 43. Note that the memory 43 may store only the application program P41 and the block protocol client program P45, or may store only the application program P41 and the file protocol client program P43. Further, each program and information stored in the memory 43 may be stored in the storage device 44.

The storage device 44 stores the operating system, management information, etc. of the client 40.

The application program P41 is executed by the CPU 42 and requests the file protocol client program P43 and the block protocol client program P45 to read and write data from and to the unified storage 1 or the external server 200.

The file protocol client program P43 receives various requests such as Read/Write from the application program P41 and the like, and processes file protocols included in the requests. For example, the file protocol client program P43 processes protocols such as an NFS, an SMB, a client-specific protocol, and an HTTP.

The block protocol client program P45 receives various requests such as Read/Write from the client 40 and the like and processes block protocols included in the requests.

The block protocol client program P45 is equivalent to the program stored in the memory 203 of the external server 200.

The storage device 44 stores the operating system, management information, etc. of the client 40.

### Tables in First Embodiment

FIG. 8 is a diagram illustrating an example of the port management table T10.

The port management table T10 is a management table used by the controller 100 to manage each logical port set in the unified storage 1. Each of the rows of the port management table T10 indicates the configuration of each logical port of the unified storage 1.

The port management table T10 includes a logical port ID C101, a controller ID C102, an FE I/F ID C103, a physical port ID C104, an IP address C105, a protocol type C106, and a secret key C107.

The logical port ID C101 stores the identifier of the corresponding logical port in the unified storage 1. The controller ID C102 stores the identifier of the controller to which the corresponding logical port belongs. The FE I/F ID C103 stores the identifier of the FE I/F 110 having the network I/F 111 to which the corresponding logical port is set. The physical port ID C104 stores the identifier of the network I/F 111 to which the corresponding logical port is set. The IP address C105 stores the IP address set to the corresponding logical port. The protocol type C106 stores the protocol type set to the corresponding logical port. Examples of protocol types include “NFS”, “SMB”, “iSCSI”, “NVMe/TCP”, and “FC”, but are not limited thereto. The secret key C107 stores a secret key for accessing the corresponding logical port. Secret keys include a CHAP (Hash Based Message Authentication Code) secret, a DH (Diffie Hellam)-HMAC (Hash Based Message Authentication Code)-CHAP secret, etc., but are not limited thereto.

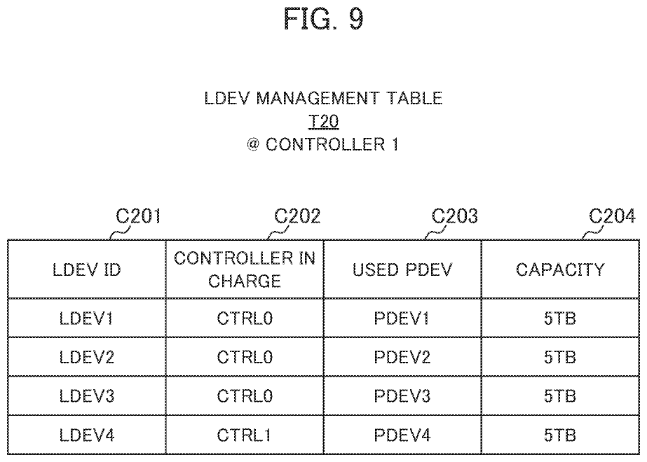

FIG. 9 is a diagram illustrating an example of the LDEV management table T20.

The LDEV management table T20 is a management table used by the controller 100 to manage the LDEVs.

Each of the rows of the LDEV management table T20 indicates the configuration of the LDEV managed by the unified storage 1. The controller 100 shares configuration information of all LDEVs in the unified storage 1. A controller in charge is assigned to each LDEV, and the controller 100 which processes the LDEV can be changed by changing the controller in charge.

The LDEV management table T20 has an LDEV ID C201, a controller in charge C202, a used PDEV C203, and a capacity C204.

The LDEV ID C201 stores the identifier of the corresponding LDEV. The controller in charge C202 stores the identifier of the controller in charge for the corresponding LDEV. The used PDEV C203 stores the identifier of a PDEV which stores LDEV data. The capacity C204 stores the capacity of the corresponding LDEV.

In the present embodiment, the LDEVs have one-to-one correspondence to the PDEVs, but this is merely an example. For example, as with the thin provisioning function, it is also possible to create a share disk pool from one or more PDEVs and virtually cut out only the required capacity to use it as the LDEV.

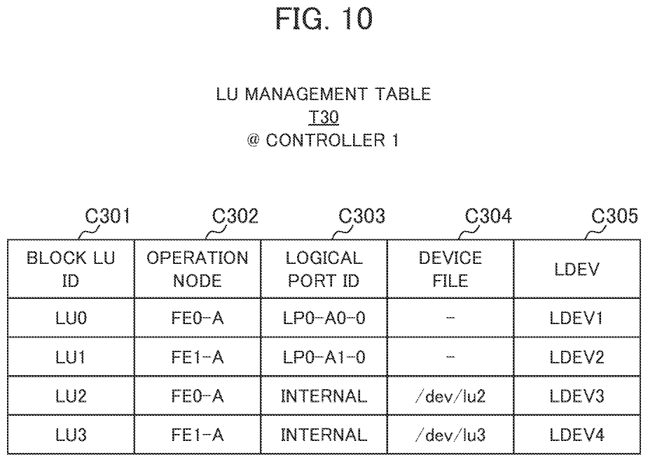

FIG. 10 is a diagram illustrating an example of the LU management table T30.

The LU management table T30 is a management table used by the controller 100 to manage LUS.

Each row of the LU management table T30 indicates the configuration of the LU managed by the unified storage 1.

The LU management table T30 has a block LU ID C301, an operation node C302, a logical port ID C303, a device file C304, and an LDEV C305.

The block LU ID C301 stores the identifier of the corresponding LU. The operation node C302 stores the identifier of the FE I/F 110 which processes the corresponding LU. The logical port ID C303 stores the identifier of the logical port which exposes the corresponding LU. The client 40 can access the corresponding LU using the access protocol stored in the protocol type C106 of the port management table T10. When the LU is used for the file system, the logical port ID C303 becomes “internal”. The device file C304 stores a device file name when the LU is used for the file system. When the LU is not used for the file system, the device file C304 is made blank. The LDEV C305 stores the identifier of the LDEV assigned to the corresponding LU.

FIG. 11 is a diagram illustrating an example of the FS management table T40.

The FS management table T40 is a management table commonly used by the unified storage 1 and the external server 200 to manage fila systems.

Each row of the FS management table T40 indicates the configuration of each file system to be managed.

The FS management table T40 has an FS ID C401, an operation node C402, a device file C403, and an FS type C404.

The FS ID C401 stores the identifier of the corresponding FS. The operation node C402 stores the identifier of a node which processes the corresponding FS. The unified storage 1 stores the identifier of the FE I/F 110, and the external server 200 stores the identifier of the external server 200, respectively. The device file C403 stores a device file name of an LU which stores the corresponding FS. The device file as defined here refers to a specific file used to access a physical device. A program can read from and write to an actual physical device by reading from and writing to the device file. The FS type C404 stores the type of the file system. In addition to OSS file systems such as “XFS”, “Ext4”, and “ZFS”, a vendor-specific commercial file system can be stored as the type of file type.

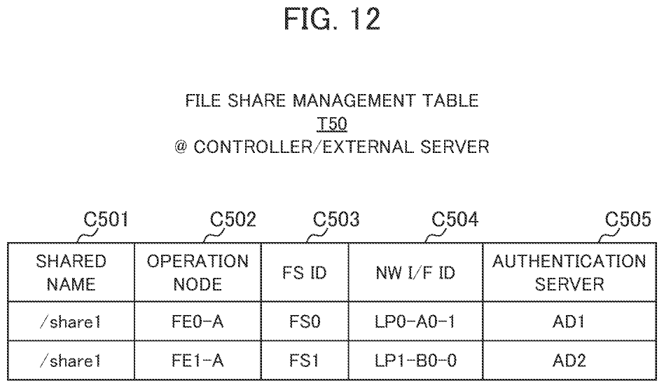

FIG. 12 is a diagram illustrating an example of the file share management table T50.

The file share management table T50 is a management table commonly used by the unified storage 1 and the external server 200 to manage a file share.

Each row of the file share management table T50 indicates the configuration of the file share to be managed.

The file share management table T50 has a share name C501, an operation node C502, an FS ID C503, an NW I/F ID C504, and an authentication server C505.

The share name C501 stores the identifier of the file share. The operation node C502 stores the identifier of a node which processes the corresponding file share. The unified storage 1 stores the identifier of the FE I/F 110, and the external server 200 stores the identifier of the external server 200, respectively. The FS ID C503 stores the identifier of a file system to be shared. The NW I/F ID C504 stores a network interface which exposes the file share. In the unified storage 1, the NW I/F ID C504 stores the identifier of a logical port which exposes the corresponding file share. The client 40 accesses the file share using the file protocol set in the logical port. In the external server 200, the identifier of the network I/F 201 is stored in the NW I/F ID C504. The authentication server C505 stores the host name or IP address of an authentication server which performs authentication processing at the time of file share connection. The authentication server C505 may be, for example, an Active Directory (AD) server, but is not limited thereto.

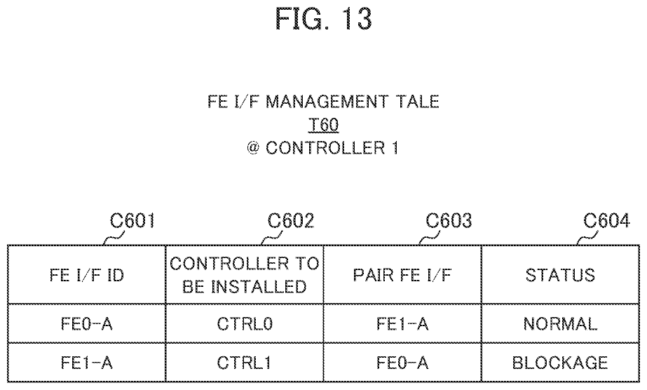

FIG. 13 is a diagram illustrating an example of the FE I/F management table T60.

The FE I/F management table T60 is used by the controller 100 to manage the FE I/F 110 installed in the unified storage 1.

Each row of the FE I/F management table T60 manages the FE I/F 110 installed in the unified storage 1.

The controller 100 manages the configuration of an HA cluster of the FE I/F using the FE I/F management table T60. The HA cluster of the FE I/F is configured to span the controller 100. When a failure occurs in the FE I/F 110 or the controller 100, the file system, the file share, the LU and the LDEVs used by them are failed over to the FE I/F 110 to be paired.

The FE I/F management table T60 includes an FE I/F ID C601, a controller to be installed C602, a pair FE I/F C603, and a status C604.

The FE I/F ID C601 stores the identifier of the corresponding FE I/F 110. The controller to be installed C602 stores the identifier of the controller 100 equipped with the corresponding FE I/F 110. The pair FE I/F C603 stores the identifier of the FE I/F 110 which forms a pair with the corresponding FE I/F 110 in an HA configuration. The status C604 stores the status of the corresponding FE I/F. The status C604 stores any of “normal”, “blockage, and “stop”.

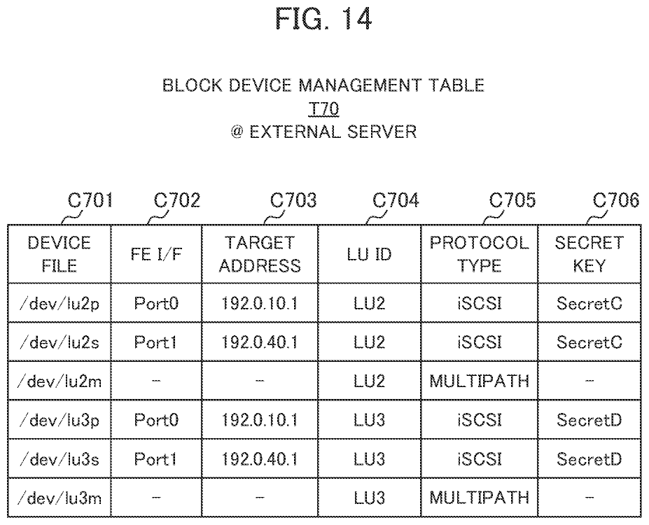

FIG. 14 is a diagram illustrating an example of the block device management table T70.

The block device management table T70 is used by the external server 200 to manage each LU of the unified storage 1 connected using the block protocol. A block device indicates a block-accessible device. Here, it corresponds to the LU provided by the unified storage 1. Programs on the external server 200 can perform block access to the block device in the same manner as the physical device.

Each row of the block device management table T70 corresponds to the block device, that is, the LU provided by the unified storage 1.

The block device management table T70 has a device file C701, an FE I/F C702, a target address C703, an LU ID C704, a protocol type C705, and a secret key C706.

The device file C701 stores a device file corresponding to the corresponding block device. By reading and writing from and to the device file, it becomes possible to read and write from and to the block device, i.e., the LU provided by the unified storage 1. Also, when configuring a multipath for the LU of the unified storage 1, p is added to the final character of the device file of the first connected path, and then s is added to the final character of the device file of the next connected path, respectively. Further, a multipath device file with m added to the final character thereof is created. The multipath referred to here means two or more redundant access paths to the LU. Each access path connects to the same LDEV via a different network I/F, FE I/F 110, and controller 100. When a failure occurs in either access path, availability can be increased by accessing the LDEV from another access path.

The FE I/F C702 stores the identifier of the network I/F 201 used for block device access. Note that the FE I/F C702 of the device file for the multipath is made blank.

The target address C703 stores the IP address of the logical port of the unified storage 1 used by the corresponding device file. Note that the target address C703 of the multipath device file is made blank.

The LU ID C704 stores the identifier of the LU of the unified storage 1 corresponding to the corresponding device file. Note that the target address LU ID C704 of the multipath device file is made blank.

The protocol type C705 stores a communication protocol used for communication with the unified storage 1. The protocol type C705 stores “iSCSI”, “NVMe/TCP”, and “FC”, but is not limited thereto. Note that the protocol type C705 of the multipath device file is defined as “multipath”.

The secret key C706 stores a secret key for accessing the corresponding device file. The secret key C706 stores a secret key corresponding to the secret key C107 of the port management table T10. Note that the secret key C706 of the multipath device file is made blank.

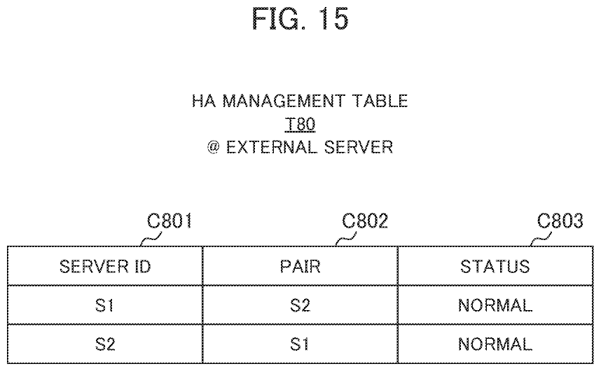

FIG. 15 is a diagram illustrating an example of the HA management table T80.

The HA management table is a management table used to configure an HA cluster by the external server 200.

Each row of the HA management table manages each external server 200 which configures the HA cluster.

The HA management table has a server ID C801, a pair C802, and a status C803.

The server ID C801 stores the identifier of the corresponding external server 200. The pair C802 stores the identifier of the external server 200 which forms a pair with the corresponding server. The status C803 stores the status of the corresponding external server 200. The status C803 stores any of “normal”, “blockage”, and “stop”.

### Flowchart of First Embodiment

FIG. 16 is a flowchart illustrating an example of the performance upgrade processing S1 of the unified storage 1 in the first embodiment.

The performance upgrade processing S1 is executed when the performance upgrade control program P70 of the management server 50 receives a performance upgrade request from a user. The performance upgrade control program P70 executes the performance upgrade according to the flow shown from S120 to S160.

(S120) The performance upgrade control program P70 issues a configuration information acquisition instruction to the unified storage 1 and acquires the port management table T10, the LDEV management table T20, the LU management table T30, the FS management table T40, and the file share management table T50 as configuration information.

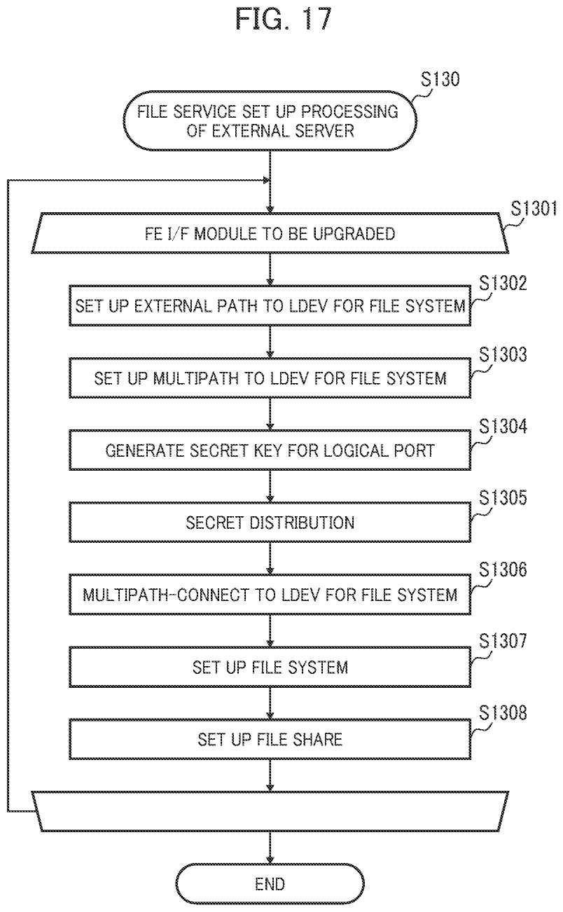

(S130) The performance upgrade control program P70 instructs the unified storage 1 to set up an access path for external connection to the LU used by the file system belonging to the FE I/F 110 to be migrated. The performance upgrade control program P70 creates a logical port for block access to register the corresponding LU and allocates the corresponding LU. Thus, the corresponding LU becomes in a state in which block connection from the outside can be made to the file system within the FE I/F 110. Further, the performance upgrade control program P70 uses the acquired file system and file share configuration information (network configuration, share configuration, secret key) to configure a file system/file share equivalent to the unified storage 1. Details of S130 will be described later with reference to FIG. 17.

(S140) The performance upgrade control program P70 configures an HA cluster between the external servers 200.

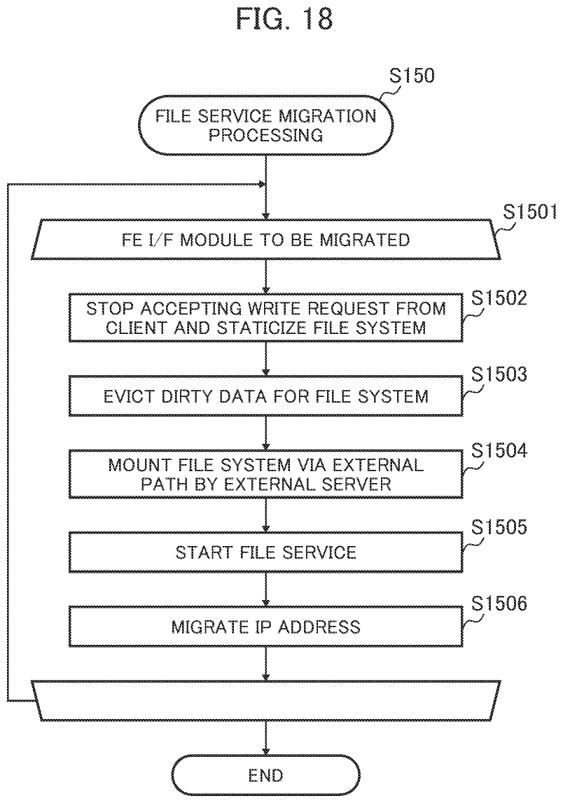

(S150) The performance upgrade control program P70 migrates the file service from the FE I/F 110 to the external server 200. Details of S150 will be described later with reference to FIG. 18.

(S160) The performance upgrade control program P70 instructs the unified storage 1 to switch the protocol type of the FE I/F 110 from file/block protocol sharing to block protocol only. The corresponding

FE I/F 110 releases the CPU and memory resources allocated for file protocol control and reallocates them to block protocol control.

As shown above, in the first embodiment, the HA cluster is configured between the external servers 200 before performing the performance upgrade (S140), and it is possible to migrate the file service while maintaining the active-active configuration. This suppresses degradation in performance and reliability due to one controller stopping during the upgrade, which was the problem in the conventional method.

Further, in the first embodiment, the FE I/F 110 to be migrated is reused as a block-dedicated I/F after the performance upgrade (S160). This enables effective use of the existing FE I/F 110 and eliminates the need for additional investment in the block-dedicated I/F.

FIG. 17 is a flowchart illustrating an example of the file service setting processing S130 of the external server 200 of the unified storage 1 in the first embodiment.

In the file service setting processing S130, the performance upgrade control program P70 of the management server 50 instructs the unified storage 1 and the external server 200 to perform various settings.

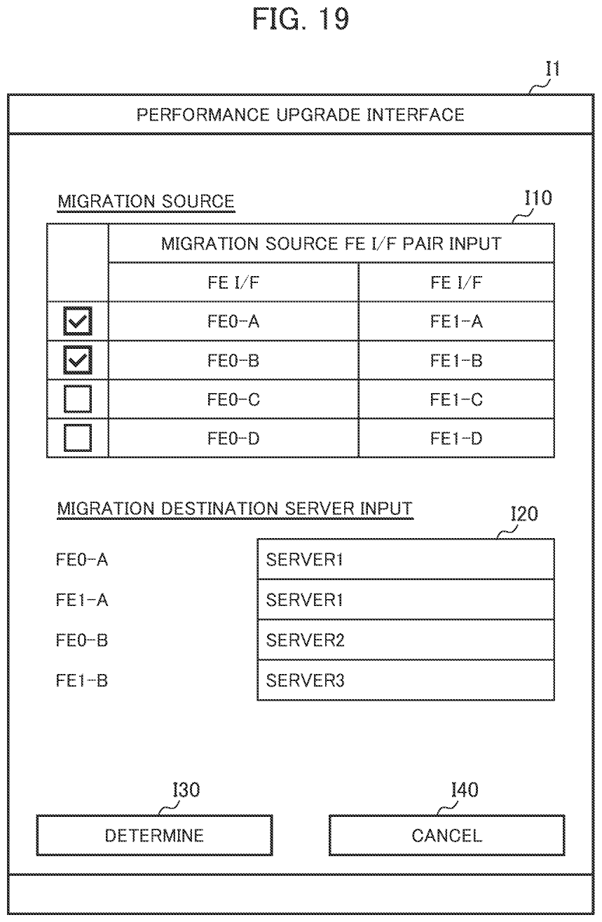

(S1301) The performance upgrade control program P70 executes the processing from S1302 to S1308 for all FE I/Fs 110 to be upgraded. The FE I/F 110 to be upgraded is specified by the user using an interface to be described later with reference to FIG. 19.

(S1302) The performance upgrade control program P70 checks the file system managed by the FE I/F 110 to be upgraded from the FS management table T40. Next, the performance upgrade control program P70 checks the LDEV used by the corresponding file system from the LU management table T30. Next, the performance upgrade control program P70 instructs the unified storage 1 to create a logical port accessible from the external server 200 for the corresponding LDEV and set up an LU. As a result, an external path is set up to the LDEV for the file system, and block access to the corresponding LDEV is enabled from the external server 200. The above processing is performed on all the corresponding LDEVs.

(S1303) The performance upgrade control program P70 set up a multipath to the LDEV of S1302. The performance upgrade control program P70 checks the FE I/F 110 which forms a pair with the FE I/F 110 to which the logical port that are set up in S1302 belongs. Next, the performance upgrade control program P70 creates a logical port accessible from the external server 200 on the FE I/F 110 which forms the HA pair, and sets up the LU of the corresponding LDEV. As a result, block access from the external server 200 to the corresponding LDEV is possible via the multipath. The above processing is performed on all the corresponding LDEVs.

(S1304) The performance upgrade control program P70 generates secret keys for LDEV access with respect to all logical ports that are set up in S1302 and S1303.

(S1305) The performance upgrade control program P70 distributes the secret key created in S1304 to the external server 200 which becomes a migration destination.

(S1306) The performance upgrade control program P70 instructs the external server 200 to connect to the LU of the unified storage 1 using the secret key distributed in S1305. LU connections are made to all LUs for the file system handled by the FE I/F 110 as a migration source. Further, the LU connections are made based on the multipath configuration set up in S1302 and S1303. The external server 200 updates the block device management table T70 based on the connected LU.

(S1307) The performance upgrade control program P70 copies the FS management table T40 to the external server 200 and updates the operation node C302 and the device file C403. The operation node C302 stores the identifier of the external server 200 itself, and the device file C403 stores the device file created in S1302.

(S1308) The performance upgrade control program P70 copies the file share management table to the external server 200 and updates the operation node C302 and the NW I/F ID C504. The operation node C302 stores the identifier of the external server 200 itself, and the NW I/F ID C504 stores the identifier of the network I/F 201.

FIG. 18 is an example of the file service migration processing S150 of the unified storage 1 in the first embodiment.

In the file service migration processing S150, the performance upgrade control program P70 of the management server 50 performs various settings on the unified storage 1 and the external server 200.

(S1501) The performance upgrade control program P70 instructs the unified storage 1 to perform processing from S1502 to S1506 on all FE I/Fs 110 to be upgraded.

(S1502) The performance upgrade control program P70 instructs the unified storage 1 to stop accepting write requests from the clients for the file systems managed by all FE I/Fs 110 to be upgraded, and to staticize the file systems. The staticization of the file systems referred to here means a state in which the change of data temporarily stops.

(S1503) The performance upgrade control program P70 instructs the unified storage 1 to perform dirty data eviction processing on the file systems managed by all FE I/Fs 110 to be upgraded. The dirty data eviction processing referred to here is processing of writing LDEV unwritten data (dirty data) stored in the cache 115 of the FE I/F 110 to the LDEV and perpetuating the same. Therefore, it is possible to prevent data inconsistency before and after migration.

(S1504) The performance upgrade control program P70 instructs the external server 200 to connect to the LU which stores the data of the file system to be migrated. This can also be said to mean that the external server 200 mounts the file system via the external path. The external server 200 connects the device file C701 of the block device management table T70 based on the FS type C404 described in the FS management table T40.

(S1505) The performance upgrade control program P70 instructs the external server 200 to start the file share service of the file share management table T50. The file protocol server program P13 starts accepting file read/write requests from the client.

(S1506) The performance upgrade control program P70 instructs the unified storage 1 and the external server 200 to migrate the IP address for file access. Specifically, the IP address of the logical port for file access of the FE I/F 110 being processed is stopped. Thereafter, the stopped IP address is set on the network I/F 201 of the external server 200. After that, the access destination of the IP address is switched using GARP.

As shown above, in the first embodiment, the processing of evicting the dirty data of the FE I/F (S1503) is performed before the file service migration. This allows file system consistency to be guaranteed before and after the migration.

As shown above, in the first embodiment, the FE I/F device (FE I/F 110 in the above example) which can control both block access and file access is upgraded, and the apparatus (external server 200 in the above example) to be used after the upgrade is used as the FE I/F device for performing file access. The FE I/F device (FE I/F 110 in the above example) used before the upgrade is used to perform block access.

Also, in the first embodiment, when setting the file service of the upgraded apparatus (external server 200 in the above example), the multipath is configured between the upgraded apparatus (external server 200 in the above example) and the unified storage 1, and the access path for the LDEV is made redundant (S1302, S1303). Thus, even when a failure occurs in any of the FE I/F 110, the controller 100, and the network I/F 201 of the external server 200, quick service restoration becomes possible, and high availability can be realized.

Further, in the first embodiment, the unified storage system A supporting the block access and the file access has the file system (FS) which processes the file access from the client 40 and performs the block access to the controller 100. The controller 100 processes the block access from the client 40 and the block access from the file system to access the storage device (storage device unit 20 in the above example) which stores the data therein. The unified storage system A is capable of adding the network-connected information apparatus (external server 200 in the above example) and migrating the file system (FS) to the information apparatus.

Also, in this case, the file system (FS) is running on the network interface (FE I/F 110 in the above example) before the migration. On the other hand, after the file system (FS) is migrated, the file system (FS) of the information apparatus (external server 200 in the above example) performs block access to the controller 100 of the storage node (storage control device 10 in the above example). In this case, the conventionally-used network interface can be effectively utilized.

Further, in the first embodiment, the configuration information of the file service is acquired from the storage controller (FE I/F 110 in the above example) used before the upgrade, and the equivalent configuration of file service is set to the upgraded apparatus (external server 200 in the above example). Setting the access path for external connection to the logical device (LDEV) used before the upgrade provides migration to the upgraded apparatus (external server 200 in the above example) without data migration. That is, by using the same file system as the FE I/F 110 on the external server 200, there is no need to migrate the file data at the time of performance upgrade.

Furthermore, in the first embodiment, after the file system (FS) is migrated, the storage node (storage control device 10 in the above example) and the information apparatus (external server 200 in the above example) have a secret key, and perform communications including the block access between the storage node and the information apparatus using the secret key. This makes it possible to maintain security even when the external server 200 is performance upgraded.

Then, in the first embodiment, the storage node (storage control device 10 in the above example) has a network interface (FE I/F 110 in the above example). The network interface has a memory (cache 115 in the above example) in which file accessed data is temporarily stored. When the file system (FS) is migrated, dirty data in the memory of the network interface is stored in the storage device (storage device unit 20 in the above example). In this case, it is possible to prevent data inconsistency before and after migration.

Further, in the first embodiment, the storage node (storage control device 10 in the above example) has the network interface (FE I/F 110 in the above example). Before migration of the file system (FS), the block access path and file access path from the client 40 are set up onto the network interface of the storage node. After the file system (FS) is migrated, the file access path from the client 40 is set up to the information apparatus (external server 200 in the above example) in the state in which the block access path from the client 40 is set on the network interface of the storage node.

Incidentally, in the first embodiment, when the configuration of any of the storage nodes (storage control device 10 in the above example) is upgraded, the file system (FS) is migrated to the information apparatus (external server 200 in the above example). That is, it is not necessary to upgrade all of the storage nodes, and some of them can also be upgraded. In the case described above, when the FE I/F 110 is upgraded, the file system (FS) is migrated to the information apparatus. Thus, when the configuration of any of the storage nodes runs out of resources, it is possible to upgrade a target which ran out of resources.

### User Interface in First Embodiment

FIG. 19 is an example of the performance upgrade interface of the unified storage 1 in the first embodiment.

The management server program P60 of the management server 50 provides the user with an operation unit for upgrading of the performance from the FE I/F 110 to the external server 200 using the performance upgrade interface I1.

The performance upgrade interface Il has a migration source FE I/F pair input 110, a migration destination server input 120, a decision button 130, and a cancel button I40.

The migration source FE I/F pair input I10 is an interface to select an FE I/F pair which serves as a migration source. The user selects a pair of FE I/Fs 110 to be migrated from among the FE I/Fs 110 which perform the file protocol processing using check boxes.

The migration destination server input I20 is a text box to input a server which serves as a migration destination. The user inputs the host name or IP address of the server which serves as the migration destination.

The decision button 130 is an interface for instructing performance upgrade execution based on the input contents.

The cancel button 140 is an interface for canceling the performance upgrade based on the input contents.

### Second Embodiment

In a second embodiment, as in the first embodiment, a SmartNIC unified in which a SmartNIC is installed in the conventional block storage is assumed. The second embodiment has the same problems and objects as in the first embodiment.

The second embodiment differs from the first embodiment in that a NAS (Network Attached Storage) gateway server is used instead of the external server as a performance upgrade destination. The NAS gateway server referred to here means a dedicated device for file protocol control which is connected to the block storage. By using the NAS gateway server, a client can perform file access to data stored in the block storage via a file protocol. Generally, the NAS gateway server can achieve higher performance and higher usability than the external server by specializing in file protocol control.

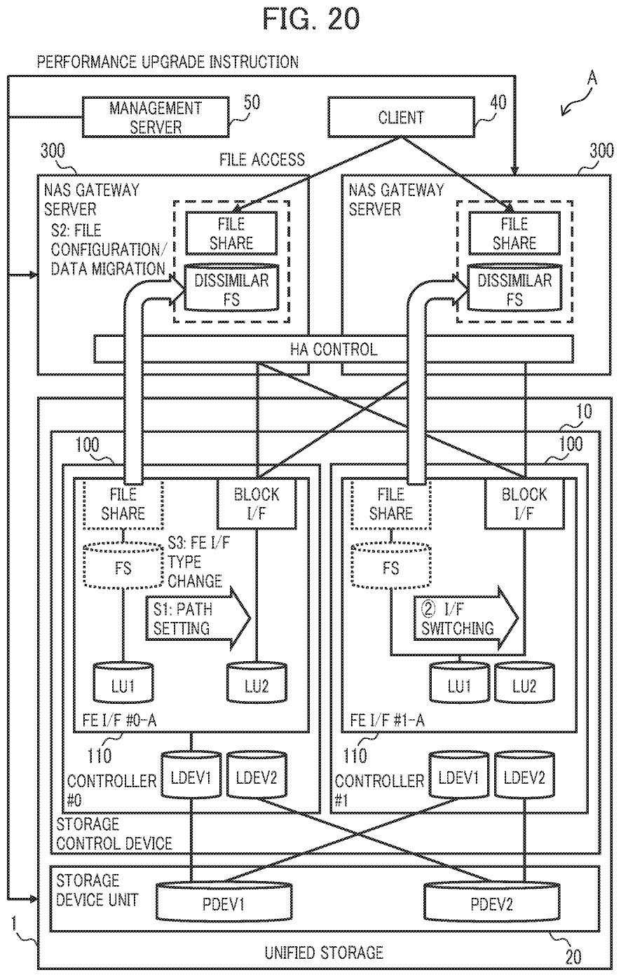

Hereinafter, the difference between the first embodiment and the second embodiment will be described with reference to FIGS. 20 to 23.

### Summary of Second Embodiment

FIG. 20 is an overall configuration diagram of a unified storage system A according to the second embodiment, and is a schematic diagram of a performance upgrade method of a unified storage 1 in the second embodiment.

The difference in system configuration from the first embodiment resides in that a performance upgrade destination of an FE I/F 110 is changed from an external server 200 to a NAS gateway server 300. The NAS gateway server 300 has file share control and file system control as with the external server 200, but the difference resides in that a customized file system optimized to the NAS is used as the file system. In the first embodiment, there was no need to migrate the file data at the time of performance upgrade by using the same file system as the FE I/F 110 on the external server 200. On the other hand, in the second embodiment, since different file systems are used between the FE I/F 110 and the NAS gateway server 300 at the time of performance upgrade, the migration of file data is executed. That is, in the second embodiment, before performing the upgrade, data is migrated from the FE I/F 110 to the file system of the NAS gateway server 300.

When a CPU of the FE I/F 110 becomes a performance bottleneck, a management server 50 performs processing of Sl' to S3′ shown below to execute a performance upgrade to the NAS gateway server 300.

(S1′) The management server 50 instructs the unified storage 1 to create a new LDEV for the NAS gateway server 300 which becomes a migration destination for the file system, and to set up an external path (LU). The management server 50 instructs the NAS gateway server 300 to create a NAS optimized file system as a migration destination on the created LU.

(S2′) The management server 50 uses the file system and file share configuration information (network configuration, share configuration, authentication server) acquired from the unified storage 1 to configure an equivalent file system and file share on the NAS gateway server 300. Note that the NAS gateway server 300 constitutes an HA cluster. Further, a temporary IP address for data migration is set to the NAS gateway server 300. Thereafter, the management server 50 instructs the NAS gateway server 300 to migrate file data from the file system of the unified storage 1 to the file system of the NAS gateway server 300. The file data migration is performed by the NAS gateway server 300 accessing the file share of the unified storage 1 and copying a file. Finally, the management server 50 uses GARP as in the first embodiment to switch an access destination of an IP address from a host. Further, the migration of the file system and file share is performed by access switching of the IP address while maintaining the active-active configuration. This suppresses degradation in performance/reliability during the upgrade, which was the problem in the conventional method.

(S3′) As in the first embodiment, the management server 50 switches the type of FE I/F 110 from file/block protocol sharing to block protocol only. This realizes effective utilization of a replaced apparatus, which was the problem in the conventional method.

The method shown above makes it possible to performance upgrade the unified storage 1 using the SmartNIC to the NAS gateway server 300. Using this method makes it possible to solve the problem of the performance upgrade of the conventional unified storage.

### System Configuration of Second Embodiment

Since an example of the overall configuration diagram of the second embodiment is equivalent to the overall configuration diagram illustrated in FIG. 2 in which the external server 200 is simply replaced with the NAS gateway server 300, the description thereof will be omitted. Since the configurations of the controller 100, the FE I/F 110, the management server 50, and the client 40 in the second embodiment are the same as those in the first embodiment, their description will be omitted.

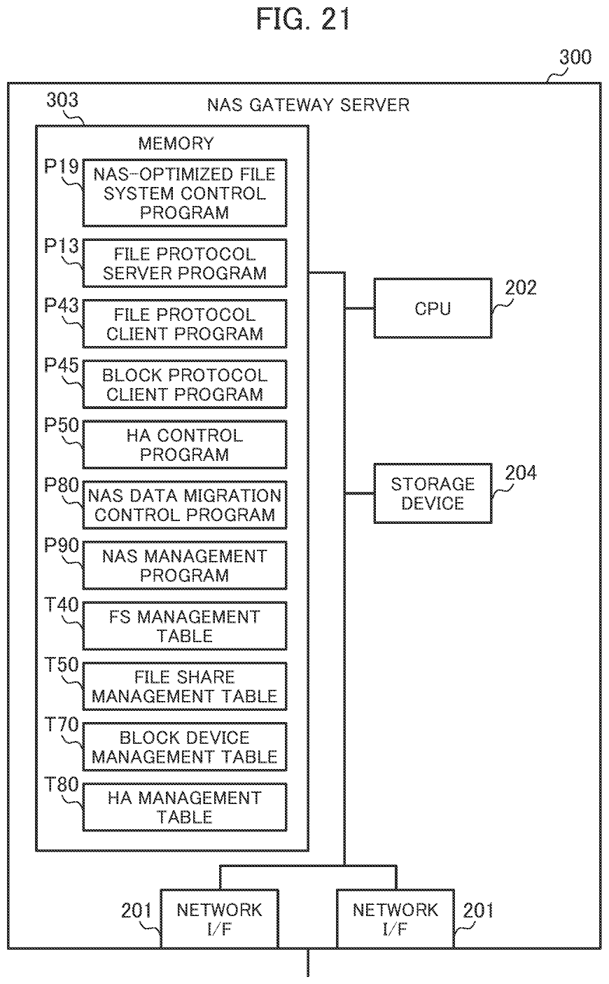

FIG. 21 is an example of a configuration diagram oof the NAS gateway server 300 in the second embodiment.

Since a hardware configuration of the NAS gateway server 300 is equivalent to that of the external server 200, the description thereof will be omitted. A memory 303 stores programs and tables other than the file system control program P11 of the external server 200. Further, a NAS optimized file system control program P19, a file protocol client program P43, a NAS data migration control program P80, and a NAS management program P90 are additionally stored in the memory 303.

The NAS optimized file system control program P19 is a program which manages a file system specific to the NAS and has a function equivalent to that of the file system control program P11. The NAS optimized file system control program P19 stores data of the file system in an LU in a format different from that of the file system control program P11. Therefore, the LU used by the file system control program P11 cannot be used directly from the NAS optimized file system control program P19.

Since the file protocol client program P43 is equivalent to the file protocol client program P43 possessed by the external server 200 and the client 40, the description thereof will be omitted. The NAS gateway server 300 uses the file protocol client program P43 in order for the NAS data migration control program P80 to access a file share in another storage device.

The NAS data migration control program P80 is a program which mounts a file share provided by another storage device and migrates file data to the NAS optimized file system inside the NAS gateway server 300. In the second embodiment, the NAS data migration control program P80 mounts a file share of the unified storage 1 and migrates file data to the NAS optimized file system of the NAS gateway server.

The NAS management program P90 provides an interface for managing the file system, the file share, and the LU connections managed by the NAS gateway server 300 to the outside.

### Tables in Second Embodiment

In the second embodiment, since the same tables as in the first embodiment are used, the description thereof will be omitted. However, in the second embodiment, table changes/references to the NAS gateway server 300 are performed via the NAS management program P90.

### Flowchart in Second Embodiment

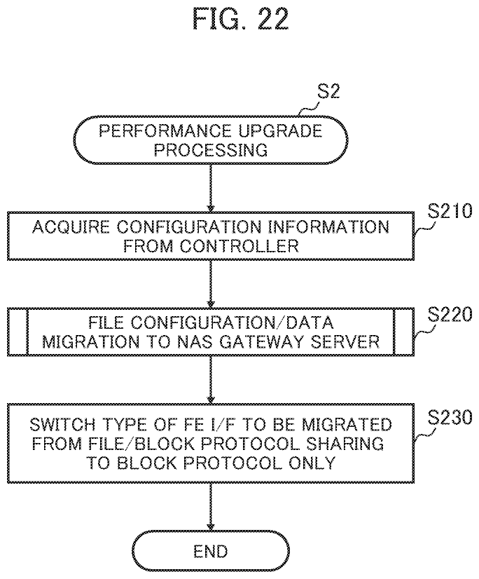

FIG. 22 is a flowchart illustrating an example of the performance upgrade processing S2′ of the unified storage 1 in the second embodiment. The performance upgrade processing S2′ is executed when the performance upgrade control program P70 of the management server 50 receives a performance upgrade request from the user.

The performance upgrade processing S2′ is executed by the performance upgrade control program P70 issuing various requests to the unified storage 1 and the NAS gateway server 300 in the flow shown in S210 to S230.

(S210) The performance upgrade control program P70 issues a configuration information acquisition instruction to the unified storage 1 and acquires the port management table T10, the LDEV management table T20, the LU management table T30, the FS management table T40, and the file share management table T50 as configuration information.

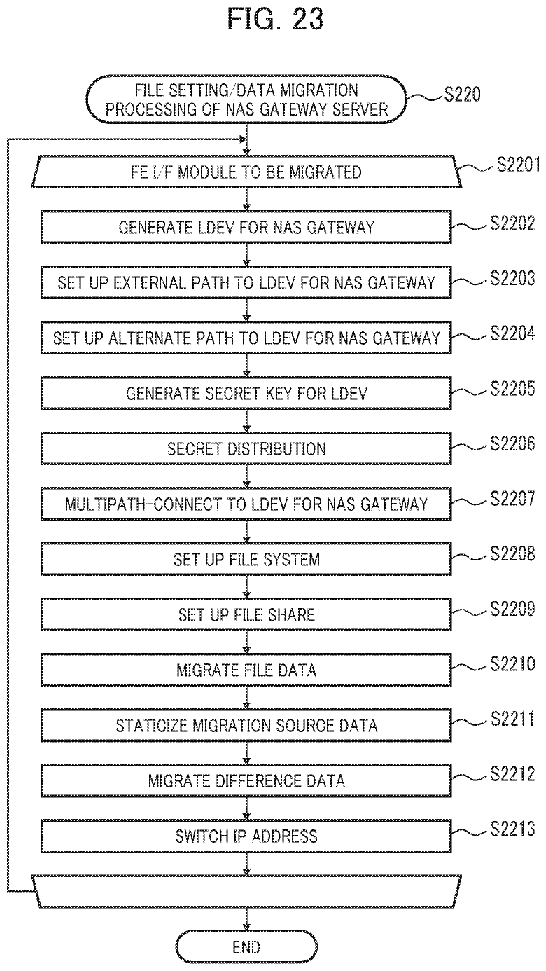

(S220) The performance upgrade control program P70 instructs the unified storage 1 to create LDEVs used by the NAS gateway server 300 as a migration destination for all file systems to be migrated. The performance upgrade control program P70 creates a logical port for block protocol which can be accessed by the NAS gateway server 300 and allocates an LU corresponding to the LDEV for the NAS gateway server 300. Thereafter, the performance upgrade control program P70 instructs the NAS gateway server 300 to migrate the configuration information and data of the FE I/F 110. Details of the present processing will be described later with reference to FIG. 23.

(S230) The performance upgrade control program P70 instructs the unified storage 1 to switch the protocol type of the FE I/F 110 from file/block protocol sharing to block protocol only. Since the present processing is equivalent to S160, the description thereof will be omitted.

FIG. 23 is a flowchart illustrating an example of the file setting/data migration processing S220 of the NAS gateway server 300 in the second embodiment.

In the file setting/data migration processing S220, the performance upgrade control program P70 of the management server 50 performs various settings on the unified storage 1 and the NAS gateway server 300.

(S2201) The performance upgrade control program P70 performs processing of S2202 to S2213 for all FE I/Fs 110 to be upgraded. The user specifies the FE I/F 110 to be upgraded.

(S2202) The performance upgrade control program P70 checks the file system managed by the FE I/F 110 to be upgraded from the FS management table T40. Next, an LDEV to be used by the NAS gateway server 300 as a migration destination is created with respect to the file system corresponding to the performance upgrade control program.

(S2203) The performance upgrade control program P70 instructs the unified storage 1 to create a logical port accessible from the NAS gateway server 300 and to allocate the LU of the LDEV created in S2202. As a result, an external path is set up to the corresponding LDEV from the NAS gateway server 300, and block access to the corresponding LDEV is enabled from the NAS gateway server 300. The above processing is performed on all the corresponding LDEVs created in S2202.

(S2204) The performance upgrade control program P70 sets up a multipath to the LDEV in S2203. Since the present processing is equivalent to S1303, the description thereof will be omitted.

(S2205) The performance upgrade control program P70 generates secret keys for LDEV access for all logical ports that are set up in S2203 and S2204.

(S2206) The performance upgrade control program P70 distributes the secret keys created in S2205 to all the migration destination NAS gateway servers 300.

(S2207) The performance upgrade control program P70 instructs the NAS gateway server 300 to connect the LU using each secret key distributed in S2206. The LU connection is made to all the LUs for the file systems handled by the migration source FE I/F 110. Further, the LU connection is performed using the multipath configurations set up in S2203 and S2204. The NAS gateway server 300 updates the block device management table T70 on the basis of the LU-connected contents.

(S2208) The performance upgrade control program P70 instructs the NAS gateway server 300 to create a file system equivalent to the FS management table T40. At this time, the LU connected in S2207 is specified as a file data storage destination LU.

(S2209) The performance upgrade control program P70 instructs the NAS gateway server 300 to create a file share equivalent to the file share management table T50. The NAS gateway server 300 updates the operation node C302 and the NW I/F ID C504. The operation node C302 stores the identifier of the NAS gateway server 300, and the NW I/F ID C504 stores the identifier of the network I/F 201.

(S2210) The performance upgrade control program P70 instructs the NAS gateway server 300 to copy data of the file system of the unified storage 1 to the NAS optimized file system of the NAS gateway server 300. The NAS gateway server 300 uses the NAS data migration control program P80 to execute replication of data of all file systems to be migrated. The replication of file data is performed by connecting to the file share of the unified storage 1 and copying the file data to be migrated to the NAS optimized file system.

(S2211) The performance upgrade control program P70 instructs the NAS gateway server 300 to staticize the file system. The NAS gateway server 300 stops accepting write request processing from the client.

(S2212) The performance upgrade control program P70 causes the NAS gateway server 300 to migrate the differential data generated between the completion of file data migration in S2210 and the file system staticization in S2211 to the NAS optimized file system. The NAS data migration control program P80 checks the file which has a difference from the file update time and re-copies it to the NAS optimized file system. Note that the detection of the differential data using the file update time is merely an example. Alternatively, the NAS optimized file system control program P19 may record the update history from the completion of the file data migration in S2210 and use it for detection of the differential data.

(S2213) The performance upgrade control program P70 instructs the unified storage 1 and the NAS gateway server 300 to migrate the IP address for file access. Since the present processing is equivalent to S1506, the description thereof will be omitted.

In the second embodiment, when migrating the file system (FS), the data referenced by the file system (FS) is migrated to the storage device of the information apparatus (NAS gateway server 300 in this case), and after migrating, the file system (FS) accesses the storage device of the information apparatus.

### Interface in Second Embodiment

Since the interface in the second embodiment is the same as that in the first embodiment, the description thereof will be omitted.

### Third Embodiment

In a third embodiment, as in the first embodiment, a SmartNIC unified in which a SmartNIC is installed in the conventional block storage is assumed. The third embodiment has the same problems and objects as in the first embodiment.

In the third embodiment, the difference from the first embodiment is that a distributed file system is used for file systems of a unified storage 1 and an external server 200 as a migration destination. The distributed file system referred to here means a function of configuring a file system across two or more processing nodes. Examples of the distributed file system include ceph, GlusterFS, and Lustre, but are not limited thereto. With the use of the distributed file system, the performance can be scaled out by increasing the number of FE I/Fs 110 or the number of external servers 200.

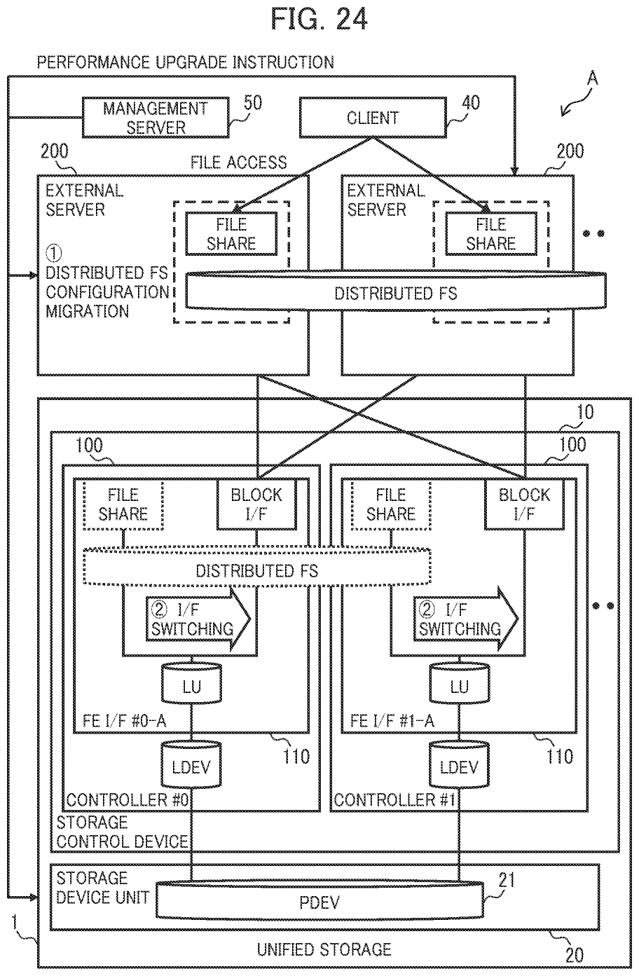

Hereinafter, the difference between the third embodiment and the first embodiment will be described with reference to FIG. 24.

### Summary of Third Embodiment

FIG. 24 is an overall configuration diagram of a unified storage system A according to the third embodiment, and is a schematic diagram of a performance upgrade method of a unified storage 1 in the third embodiment.

In the third embodiment, the difference from the first embodiment is that the FE I/F 110 and the external server 200 constitute a distributed file system (distributed FS) instead of the locally operating file system. The same distributed file system control runs on the FE I/F 110 and the external server 200. Therefore, in the third embodiment, the performance upgrade can be performed without migrating file data as in the first embodiment.

When the CPU of the FE I/F 110 becomes a performance bottleneck, the management server 50 performs the performance upgrade to the external server 200 by executing the processing of S1″ to S2″ shown below.
(S1″) The management server 50 instructs the unified storage 1 to set up an additional external path for an LU used in the distributed file system so that it can be externally connected. Consequently, the LU is placed in a situation in which block connection from the outside can be made to the distributed file system within the FE I/F 110.
(S2″) The management server 50 uses the distributed file system and file share configuration information (network configuration, share configuration, authentication server) obtained from the unified storage 1 and configures a distributed file system and file share equivalent to the FE I/F 110 on the external server. Thereafter, the management server 50 switches the access destination from the host from the FE I/F 110 to the external server 200. Since the switching of the access destination is the same as in the first embodiment, the description thereof will be omitted.

By the method shown above, the method described in the first embodiment can be applied even in the configuration using the distributed file system.

Since the configuration, tables, flows, and interfaces in the third embodiment are the same as those in the first embodiment, their description will be omitted. Note that in the third embodiment, the function equivalent to the file system in the first embodiment becomes the distributed file system. Further, the configuration of the first embodiment in which the servers having the local file systems form the HA cluster becomes the configuration in which the distributed file system is formed among the servers in the third embodiment.

In the third embodiment, the storage node (storage control device 10 in the above example) has a plurality of network interfaces (FE I/F 110 in the above example) each having a processor (CPU 113 in the above example). Before migrating each file system (FS), a plurality of file systems (FS) running on the network interfaces cooperate with each other to configure a distributed file system. After migrating each file system (FS), a plurality of file systems (FSs) running on a plurality of information apparatuses (external server 200 in the above example) cooperate with each other to configure a distributed file system.

### Description of Upgrade Method for Unified Storage System

The processing performed by the management server 50 described above is realized by cooperation of software and hardware resources.

Accordingly, the processing performed by the unified storage system A is considered as the upgrade method for the unified storage system in which the unified storage system includes: a storage node having a controller; and a storage device configured to store data, and supports block access and file access, the upgrade method including: providing a file system configured to process file access from a client to perform block access to the controller; causing the controller to process block access from the client and block access from the file system to access the storage device that stores the data; and causing the unified storage system to add a network-connected information apparatus and to migrate the file system to the information apparatus.

Although the present embodiment has been described above, the technical scope of the present invention is not limited to the scope described in the above embodiment. It is clear from the description of the claims that various changes or improvements made to the above embodiments are also included within the technical scope of the present invention.

What is claimed is:

1. A unified storage system comprising:
a storage node having a controller; and
a storage device configured to store data,
wherein the unified storage system supports block access and file access,
wherein the unified storage system includes a file system, that is configured to process file access from a client and perform block access to the controller,
wherein the controller processes block access from the client and block access from the file system to access the storage device which stores the data, and
wherein the unified storage system is capable of adding a network-connected information apparatus and is capable of migrating the file system to the information apparatus.

2. The unified storage system according to claim 1, wherein after the file system is migrated, the file system of the information apparatus performs block access to the controller of the storage node.

3. The unified storage system according to claim 1, including a network interface having a processor,
wherein the file system is running on the network interface before migrating of the file system.

4. The unified storage system according to claim 1, wherein when any of the storage nodes is upgraded in configuration, the file system is migrated to the information apparatus.

5. The unified storage system according to claim 1, wherein when the file system is migrated, configuration information of a file service is migrated from the storage node to the information apparatus.

6. The unified storage system according to claim 1,
wherein the storage node includes a plurality of network interfaces each having a processor,
wherein before migrating of the file system, the file systems running on the network interfaces configure a distributed file system in cooperation, and
wherein after migrating of the file system, the file systems running on a plurality of the information apparatuses configure a distributed file system in cooperation.

7. The unified storage system according to claim 1, wherein when the file system is migrated, the file system migrates data referenced by the file system to the storage device of the information apparatus, and after the file system is migrated, the file system accesses the storage device of the information apparatus.

8. The unified storage system according to claim 1,
wherein the storage node has a network interface,
wherein before the file system is migrated, the network interface of the storage node is configured so that a block access path and a file access path from the client are set up on the network interface, and
wherein after the file system is migrated, the network interface of the storage node is configured so that the file access path from the client is set up to the information apparatus in a state in which the block access path from the client is set up on the network interface of the storage node.

9. The unified storage system according to claim 1, wherein after the file system is migrated, the storage node and the information apparatus have a secret key and perform communication including the block access between the storage node and the information apparatus using the secret key.

10. The unified storage system according to claim 1,
wherein the storage node has a network interface,
wherein the network interface has a memory in which data subjected to the file access is temporarily stored, and
wherein when the file system is migrated, the storage device stores dirty data in the memory of the network interface.

11. The unified storage system according to claim 1, wherein the information apparatus is an external server or a NAS gateway server.

12. An upgrade method for a unified storage system comprising:
a storage node having a controller; and
a storage device configured to store data, and supporting block access and file access,
the upgrade method comprising:
providing a file system, that is configured to process file access from a client and perform block access to the controller;
causing the controller to process block access from the client and block access from the file system to access the storage device that stores the data; and
causing the unified storage system to add a network-connected information apparatus and to migrate the file system to the information apparatus.
